(19) United States
(12) Patent Application Publication
(10) Pub. No.: US 2006/0037018 A1
(43) Pub. Date: Feb. 16, 2006

(54) System, method and software providing an adaptive job dispatch algorithm for large distributed jobs

(75) Inventors: Yung-Chin Fang, Austin, TX (US); Jenwei Hsieh, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 10/919,204

(22) Filed: Aug. 16, 2004

(51) Int. Cl. G06F 9/46

(52) U.S. Cl. 718/100

(57) ABSTRACT

A system, method and software are disclosed for scheduling the dispatch of large data processing operations. In an exemplary embodiment, the software identifies a plurality of information handling system nodes to receive a first dispatch of data processing operations. Identification of the nodes is generally directed to selection of a plurality of nodes substantially evenly distributed across one or more bottleneck points in a node network. Following dispatch of data processing operations, throughput on the network, such as at a bottleneck point, is measured to determine whether network throughput is approaching a saturation threshold. If data throughput is approaching a saturation threshold, the software delays additional dispatches of data processing operations until network throughput regresses from the saturation threshold. While data throughput is not approaching a saturation threshold, the software continues to dispatch data processing operations substantially evenly across one or more network bottleneck points.

### TECHNICAL FIELD

The present disclosure relates generally to data processing and, more particularly, to job process scheduling across multiple information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In an effort to increase computing capacity, it is now commonplace for large data processing centers to couple hundreds(100s) to thousands (1,000s) of information handling systems to create greater processing capabilities. Such massive computing capabilities may be employed for modeling global weather and environmental patterns, performing gene sequencing, as well as performing myriad other tasks.

In such configurations, large distributed jobs are often communicated to the networked information handling systems en masse. In other words, the numerous job processes to be performed in the completion of an overall project are often offloaded in large batches to the information handling systems in the configuration. This off loading of large batches of job processes often results in the filling up a first rack of servers, a second rack of servers, a third rack of servers, and so on until all jobs have been dispatched for processing. In many instances, such job dispatching leads to rack switch saturation, backbone core saturation, trunk saturation as well as other data flow bottlenecks and performance degradation events. As a result, data processing centers commonly experience significant network performance degradation and increased wait time for processing results.

### SUMMARY

In accordance with teachings of the present disclosure, a system and method are described for scheduling the dispatch of large data processing operations. In an exemplary embodiment, software is used to identify information handling system nodes to receive a first dispatch of data processing operations. The identified nodes are distributed substantially evenly across bottleneck points in a node network. Following dispatch of the data processing operations, throughput on the network is measured to determine whether network throughput is approaching a saturation threshold. If so, the software delays additional dispatches of data processing operations until network throughput regresses from the saturation threshold. Otherwise, if data throughput is not approaching a saturation threshold, the software continues to dispatch data processing operations.

In one aspect, the present disclosure provides the technical advantage of enhancing the efficacy and efficiency with which distributed jobs may be processed.

In another aspect, the present disclosure provides the technical advantage of reducing or eliminating throughput bottlenecks resulting from bulk dispatches of job processing requests.

In still another aspect, the present disclosure provides the technical advantage of reducing or eliminating network performance degradation typically flowing from large distributed job processing.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram depicting one embodiment of networked information handling system node deployment according to teachings of the present disclosure;

FIG. 2 is a block diagram depicting one embodiment of an information handling system according to teachings of the present disclosure;

FIG. 3 is a flow diagram depicting one embodiment of a method for scheduling the release of a plurality of data processing job dispatches among a plurality of information handling system nodes according to teachings of the present disclosure; and

FIG. 4 is a flow diagram depicting a further embodiment of a method for scheduling the release of a large distributed job processing operation among a plurality of information handling system nodes according to teachings of the present disclosure.

### DETAILED DESCRIPTION

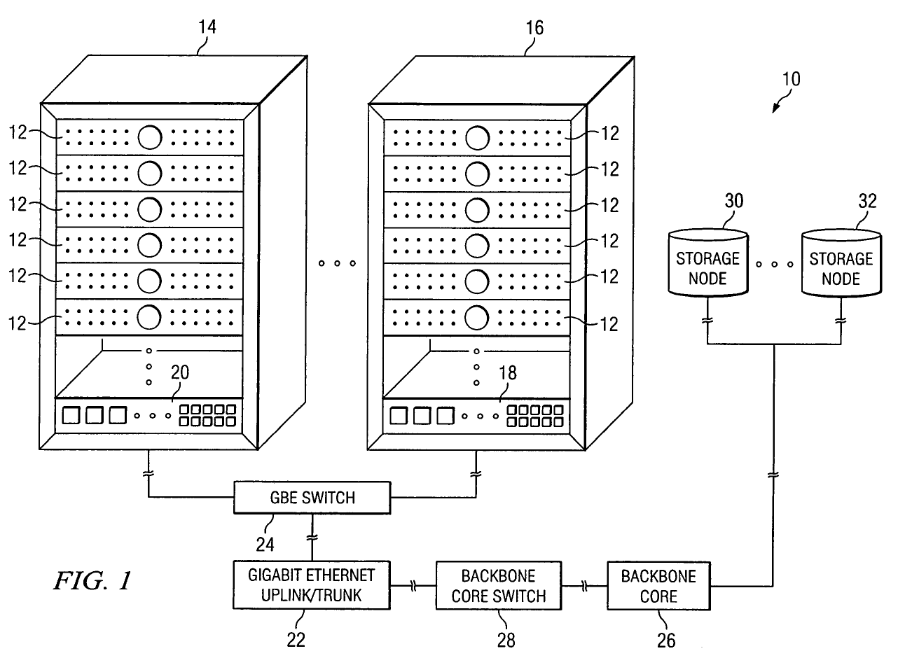

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

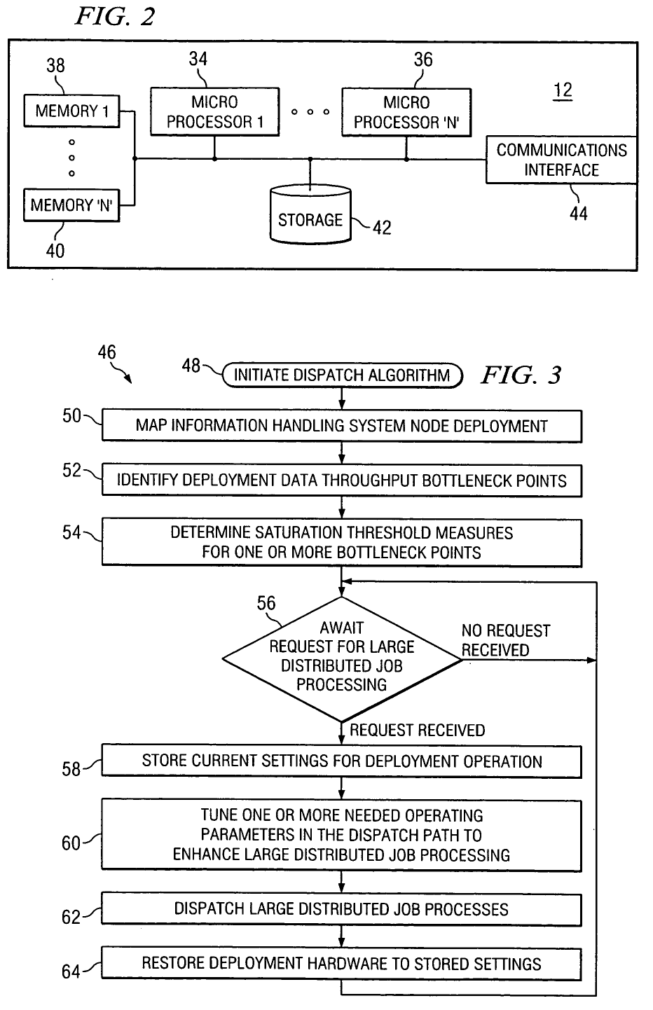

Referring now to FIGS. 1 and 2, a schematic drawing depicting a networked information handling system node deployment and a schematic diagram depicting components included in an exemplary information handling system node according to teachings of the present disclosure are shown, respectively. Alternative implementations of a networked information handling system node deployment may be leveraged with teachings of the present disclosure and, as such, FIG. 1 is provided in part as an exemplar of one such deployment embodiment. Similarly, referring specifically to FIG. 2, components included in an exemplary embodiment of an information handling system node may be varied without departing from the spirit and scope of teachings of the present disclosure.

Illustrated generally at 10 in FIG. 1 is an exemplary embodiment of a multi-node information handling system deployment capable of performing processing operations for large distributed jobs as well as to operate in other capacities. As depicted in FIG. 1, exemplary multi-node information handling system deployment 10 preferably includes a plurality of information handling system nodes, such as one or more single or multi-processor rack-mounted servers 12. As illustrated in FIG. 1, information handling system nodes 12 may be mounted in a plurality of industry standard or custom configured component racks 14 and 16.

Also preferably included in exemplary information handling system node deployment 10 are a plurality of switches, such as rack switches 18 and 20. In a preferred embodiment, such as exemplary information handling system node deployment 10, a rack switch is preferably included with a respective batch of rack-mounted servers 12. In one embodiment, a rack 14 or 16 may include up to thirty-two (32) servers 12 and a single rack switch 18 or 20. In general, switches or rack switches 18 and 20 serves as a conduit or connection point to a communications network for the one or more servers 12 coupled thereto.

As illustrated in exemplary multi-node information handling system deployment 10, a communications network may be provided using a plurality of components. In the exemplary embodiment, servers 12 may be coupled through rack switches 18 and 20 to Gigabit Ethernet uplink/trunk 22. Although rack switches 18 and 20 may be coupled directly to Gigabit Ethernet uplink/trunk 22, Gigabit Ethernet switch 24 may be used to couple rack switches 18 and/or 20 to Gigabit Ethernet uplink/trunk 22 in some embodiments. In at least one such embodiment, rack switches 18 and 20 may be coupled to Gigabit Ethernet switch 24 via Ethernet cable, GbE cable. Although not expressly shown, servers 12 and rack switches 18 and 20 may be coupled to Gigabit Ethernet uplink/trunk 22 via one or more routers, bridges, hubs, additional switches, as well as other communicative components.

Gigabit Ethernet uplink/trunk 22 may also be connected to one or more additional communication network configurations. As illustrated in FIG. 1, Gigabit Ethernet uplink/trunk 22 may be coupled to backbone core 26. Backbone core switch 28 may be provided between Gigabit Ethernet uplink/trunk 22 and backbone core 26. Note that in at least one embodiment, Backbone core switch 28 and backbone core 26 are included as part of a common unit. Although not expressly illustrated, Gigabit Ethernet uplink/trunk 22 may be coupled to backbone core 26 using one or more routers, bridges, hubs, additional switches, as well as other communicative components. It may also be possible to implement one or more portions of a communication network, such as Gigabit Ethernet uplink/trunk 22 and/or backbone core 26, using wireline, wireless and/or varied combinations thereof.

One or more of the plurality of servers 12 in racks 14 and 16 are preferably operably coupled to one or more storage nodes 30 and 32. Storage nodes 30 and 32 may be provided in a variety of forms. For example, storage nodes 30 and 32 may be provided in the form of a storage area network or SAN, network file server, or other configuration. In an exemplary embodiment, storage nodes 30 and 32 are preferably coupled to one or more servers 12 through one or more rack switches 18 and 20 via backbone core 26 and/or Gigabit Ethernet uplink/trunk 22.

Illustrated in FIG. 2 is an exemplary embodiment of components preferably included in one or more of servers 12. As illustrated in FIG. 2, an exemplary embodiment of server 12 may include one or more microprocessors 34 and 36. In addition, to one or more microprocessors 34 and 36, an exemplary embodiment of server 12 may include one or more memory devices 38 and 40. Microprocessors 34 and 36 preferably cooperate with one or more memory device 38 and 40 to execute and store, respectively, one or more instructions of a program of instructions obtained from storage 42 maintained by server 12, one or more storage nodes 30 and/or 32 operably coupled to server 12 or received via a communication network such as Gigabit Ethernet uplink/trunk 22 and/or backbone core 26.

In addition to one or more microprocessors 34 and 36, one or more memory devices, 38 and 40 and storage 42, server 12 may also include one or more communications interfaces 44. Communications interface 44 may be included and operable to couple server 12 to rack switch 18 and/or 20. Additional components may be incorporated in one or more of information handling system nodes or servers 12 deployed in accordance with teachings of the present disclosure.

Referring now to FIG. 3, a flow diagram depicting an exemplary method for managing the dispatch of large data processing jobs among the nodes of a multi-node information handling system deployment is according to teachings of the present disclosure. It should be noted that various changes and alterations may be made to exemplary method 46 of FIG. 3 without departing from the spirit and scope of its teachings.

Upon initiation of a large data processing job dispatch algorithm incorporating teachings of the present disclosure at 48, exemplary method 46 preferably proceeds to 50. In one embodiment of exemplary method 46, the multi-node information handling system deployment may be mapped at 50. Mapping of a multi-node information handling system deployment may include identifying the number of servers included in the deployment as well as the location of the servers in the deployment, such as by rack number. Mapping may also include identification of the devices connecting the plurality of servers to one another, such as identifying rack switches, hubs, routers, bridges, network backbones and/or trunks, etc.

Mapping of a multi-node information handling system deployment may also include dividing the plurality of nodes into groups, such as grouping information handling system nodes by rack location, by rack switch connection, as well as in alternative subdivisions. Mapping a multi-node information handling system deployment may be effected by interrogating interconnected hardware for one or more bits of information including, without limitation, identification, location, and capabilities. In another aspect, mapping at 50 may be performed by leveraging a deployment plan or other deployment guidance used in an original deployment of the multi-node information handling system. Maps created at 50 may be stored in one or more storage nodes 30 and 32, in storage device 42 of server 12 or in some other accessible storage implementation. Following mapping at 50, exemplary method 46 preferably proceeds to 52.

In addition to mapping the configuration of a multi-node information handling system deployment, exemplary method 46 may also provide for the identification of data throughput bottleneck points at 52. For example, rack switches 18 and 20 generally have associated therewith a maximum number of transactions they can efficiently process. In addition, one or more of storage nodes 30 and 32 may become saturated with access requests at a processor associated with the storage node, at a switch, bridge, router, hub, or other node access point. Further, one or more switches, hubs, routers, bridges or other components coupling one or more racks of servers 12 to Gigabit Ethernet uplink/trunk 22 may become saturated at certain levels of transactions. Still further, one or more switches, hubs, routers, bridges or other components coupling Gigabit Ethernet uplink/trunk 22 to backbone core 26.

Logically, as well as from observation, information handling system component performance tends to be degraded as data traffic through a bottleneck point approaches and/or reaches saturation. For example, when a rack switch is saturated, rack switch performance typically drops. As data traffic propagates from a rack switch to an Ethernet switch or a backbone core switch and the Ethernet or backbone core switch become saturated, performance in the Ethernet and/or backbone core switch will generally be degraded. Similar degradations in performance may arise in storage nodes through an overwhelming of storage node processing power and/or through saturation of a storage node entry point.

In one aspect, identification of one or more bottleneck points in a multi-node information handling system deployment may be based on logical identification or from testing. For example, logical identification may flow from knowing the capabilities of certain components, such as that a rack switch may handle only so much data at one time, or a communications network has limited bandwidth. In another aspect, data throughput bottleneck points may be identified through performing one or more communications tests across the network. Alternative methods of identifying may be implemented without departing from the spirit and scope of the present disclosure. Information gathered in identifying one or more data traffic bottleneck points may be stored in one or more storage nodes 30 and 32, in storage device 42 of server 12 or in some other accessible storage implementation.

In association with the identification of one or more bottleneck points of an information handling system deployment at 52, exemplary method 46 preferably also provides for the determination of a saturation threshold measure for the one or more bottleneck points or other communicative or processing aspects of the multi-node information handling system deployment at 54. Saturation threshold measure determinations may be performed through testing or experimentation as well as through an analysis of inherent characteristics of the components included in a multi-node information handling system deployment. Saturation threshold measures determined at 54 are preferably stored for later use as described below. A saturation threshold measure may be, for example, where a device/network leg is operating at 80% of its capacity. Alternative definitions of a saturation threshold measure are contemplated in the present disclosure.

Following determination of one or more saturation thresholds associated with one or more bottleneck points of a multi-node information handling system deployment, exemplary method 46 preferably waits at 56 for a large distributed job processing request. Until a large distributed job processing request is received exemplary method 46 may remain in a wait state at 56. Upon receipt of a request to process a large distributed job at 56, exemplary method 46 preferably proceeds to 58.

At 58, current operating setting for one or more of the components included in the information handling system multi-node deployment are preferably preserved. For example, current or standard operating standards for servers 12, rack switches 18 and 20, one or more bridges, hubs, switches, routers or other components connecting Gigabit Ethernet uplink/trunk 22 to servers 12, storage nodes 30 and 32 and/or backbone core 26, may be stored for later use at 58. In a multi-node information handling system deployment that is deployed in a configuration to optimize large distributed job processing, the operation suggested at 58 of exemplary method 46 may be unnecessary.

Exemplary method 46, in an embodiment of a multi-node information handling system deployed in a standard or other non-large distributed job processing configuration, preferably tunes one or more components of the multi-node information handling system deployment to make large distributed job processing more efficient at 60. For example, exemplary method 46 may provide for the enabling of jumbo packet processing features on one or more nodes and/or switches to enhance data transfer throughput. Alternative optimization goals may be pursued through the tuning operations preferably performed at 60 of exemplary method 46.

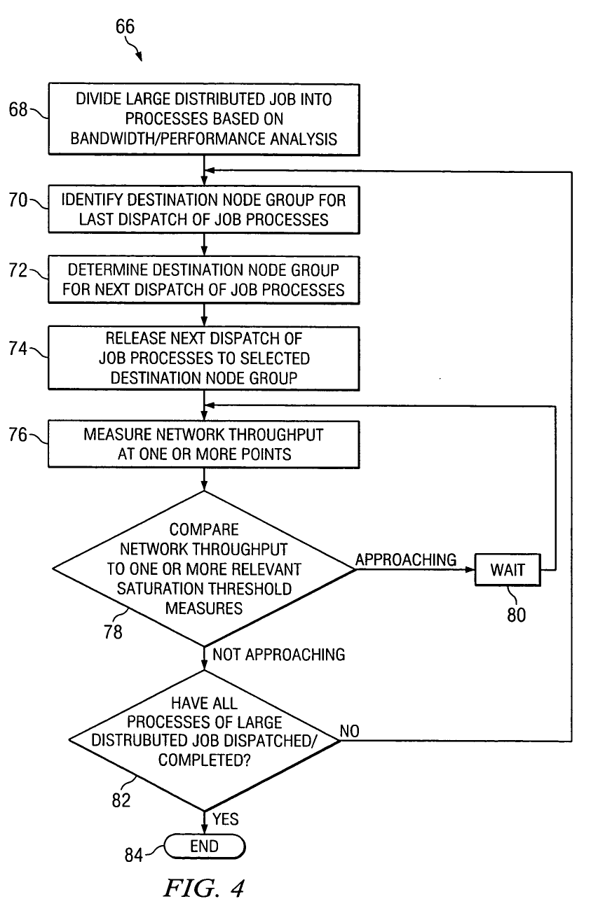

Following a tuning of one or more information handling system deployment components at 60, exemplary method 46 preferably proceeds to 62. At 62, jobs or processing dispatches associated with a current large distributed job processing request are preferably released. Additional detail regarding the release or dispatch of a large distributed job for processing are discussed in greater detail with respect to FIG. 4.

Following completion of the release or dispatch of a current large distributed job at 62, exemplary method 46 preferably proceeds to 64. One or more operational settings for the one or more information handling system components reconfigured at 60 are reset to their normal, preferred or stored settings. As mentioned above, in an embodiment where the preferred operational settings of the components in a multi-node information handling system deployment are the same settings desired for efficient processing of large distributed jobs, the operations suggested at 64 of exemplary method 46 may be omitted.

Referring now to FIG. 4, a flow diagram depicting an exemplary method for dispatching large distributed jobs across a multi-node information handling system deployment is shown. As mentioned above, exemplary method 66 of FIG. 4 generally describes operations preferably performed in association with the dispatch of large distributed job processes at 62 of exemplary method 46 illustrated in FIG. 3.

As illustrated in FIG. 4, exemplary large distributed job dispatch method 66 preferably begins at 68 by dividing a large distributed job into components or processes. In circumstances where a large distributed job is provided for processing in such pieces, operations suggested at 68 may be omitted.

For example, a large distributed job may be broken into individual processes capable of being independently completed. Further, division of a large distributed job may include packaging a number of processes which may be handled by individual nodes into groups, such as group of processes in the quantity of server racks in a particular information handling system deployment. Following the operation suggested at 68, exemplary method 66 preferably proceeds to 70 and 72.

At 70 and 72, exemplary method 66 preferably provides for a determination of the next group of information handling system nodes to receive a dispatch of at least a portion of a large distributed job. Specifically, a determination is preferably made at 70 as to the last group of one or more nodes having received a dispatch of at least a portion of a large distributed job. Further, a determination is preferably made at 72 as to the next group of one or more information handling system nodes to receive a dispatch of at least a portion of a large distributed job. Following a determination as to the next group of information handling system nodes to receive a dispatch of processes for servicing, exemplary method 66 preferably proceeds to 74.

At 74, at least a portion of the large distributed job may be dispatched or released to the designated or selected group of nodes identified at 72. For example, if the third server on each of fifty (50) server racks were identified to receive the next dispatch of a portion of the current large distributed job, fifty (50) processes or jobs serviceable by separate information handling system nodes may be released or dispatched to the identified nodes.

Following the release of at least a portion of a large distributed job to a group of one or more selected or designated information handling system nodes at 74, exemplary method 66 preferably proceeds to 76 where data traffic in the deployment may be measured. Specifically, at 76 of exemplary method 66 a saturation level for one or more locations of the information handling system communication network is preferably determined. For example, data traffic at one or more bottleneck points, such as the one or more bottleneck points identified at 52 of exemplary method 46, may be measured.

Once the data traffic has been measured, the data traffic measure can be compared to a saturation measure associated with the measurement location at 78. If at 78 it is determined that the current data traffic at the one or more measurement location approaches an associated saturation measure, exemplary method 66 preferably proceeds to a wait state at 80. In one aspect, by waiting at 80, exemplary method 66 reduces or eliminates efficiency problems associated with communications network data traffic congestion. In addition, waiting at 80 reduces or eliminates efficiency problems associated with job processing at a storage node 30 and 32 when each of plurality of processes or nodes is each trying to access executable code or data needed to complete a process. Following a wait period at 80, exemplary method 66 preferably returns to 76 to again measure network or component throughput before again proceeding to 78 for a saturation comparison.

If at 78 it is determined that network or component throughput does not currently approach or exceed an associated saturation measure, exemplary method preferably proceeds to 82. At 82, exemplary method preferably provides for a determination as to whether processing for the current large distributed job have been dispatched and/or completed.

If it is determined at 82 that processing remains to be dispatched or completed, exemplary method 66 preferably returns to 70 where the process of selecting the next batch of nodes to receive a dispatch of processing may begin. Alternatively, if at 82 it is determined that all processing for the current large distributed job have been dispatched and/or completed, exemplary method 66 preferably ends at 84 and exemplary method 46 may then proceed to 64.

For example, consider an exemplary operation of methods 46 and 66 in a multi-node information handling system deployment having one hundred (100) server racks with each rack containing thirty-two (32) servers 12 and a rack switch in each server rack. A large distributed job may be broken into groups of one hundred (100) processes, where each process is serviceable by a separate information handling system node at 68 of exemplary method 66. Initially, exemplary method 66, at 70, may determine that a dispatch for the current large distributed job has not been made. Continuing, thus, one embodiment of exemplary method 66, at 72, may determine that the first node of each of the one hundred (100) server racks are each to receive a process for servicing. As a result of such a distribution of processes, data traffic may be balanced across rack switches, a common or likely bottleneck point.

Following distribution of a batch of processes or jobs, network data traffic and/or one or more component processes workloads are preferably measured, such as at 76 of exemplary method 66. While the one or more measured values do not exceed an associated saturation value, additional portions of the large distributed job may be released to the next group of designated information handling system nodes, such as to the second server on each of the server racks in a multi-node information handling system deployment. If the measured traffic or processing capabilities are approaching a saturation measure, exemplary method 66 preferably waits for a period to allow the data traffic or processing operations to subside before seeking release or dispatch of an additional portion of a large distributed job.

Although the disclosed embodiments have been described in detail, it should be understood that various changes, substitutions and alterations can be made to the embodiments without departing from their spirit and scope.

What is claimed is:

1. Software for dispatching a large distributed data processing operation among a plurality of information handling system nodes operably coupled to a communications network, the software embodied in computer readable media and when executed operable to direct an information handling system to:
distribute a plurality of data processing jobs to a plurality of information handling system nodes, the information handling system nodes maintained in a plurality of groups with each group having at least one rack switch associated therewith;
monitor data throughput on the communications network;
while data throughput on the communications network approaches a saturation threshold measure for one or more data throughput bottleneck points, hold the distribution of additional data processing jobs; and
if data throughput is not approaching the saturation throughput threshold measure for the one or more data throughput bottleneck points, distribute one or more additional data processing jobs to one or more information handling system nodes.

2. The software of claim 1, further operable to repeat the dispatch and monitor operations until all jobs of the large distributed data processing operation have been dispatched to an information handling system node for processing.

3. The software of claim 1, further operable to tune one or more performance parameters for the plurality of information handling system nodes and associated network hardware to optimize the information handling system nodes and associated network hardware for large distributed data processing performance.

4. The software of claim 1, further operable to save current operating settings for the information handling system nodes and associated network hardware.

5. The software of claim 4, further operable to restore the operating settings for the information handling system nodes and associated network hardware to their respective stored operating settings following completion of the distribution of data processing jobs.

6. The software of claim 1, further operable to identify data throughput bottleneck points associated with the networked information handling system nodes.

7. The software of claim 6, further operable to calculate and maintain a saturation threshold associated with one or more of the identified data throughput bottleneck points.

8. The software of claim 1, further operable to map the networked information handling system nodes including identification of relationships between hostnames, node racks and rack switches.

9. A method for scheduling the processing of a plurality of data processing jobs across a plurality of networked information handling system nodes, the jobs defining at least a portion of a massive data processing operation, the method comprising:
identifying a group of information handling system nodes for receiving a dispatch of data processing jobs from an information handling system node table;
reviewing a saturation threshold associated with the group of information handling system nodes and hardware interconnecting the information handling system nodes, the saturation threshold indicating data traffic throughput capacity at one or more networked information handling system bottleneck points;
releasing a dispatch of ‘n’ data processing job dispatches to the group of information handling system nodes;
measuring data traffic throughput at one or more network bottleneck points associated with the group of nodes having received a dispatch of data processing jobs to determine a data throughput saturation measure;
pausing release of an additional dispatch of the ‘n’ data processing job dispatches and repeating the measuring data traffic throughput operation in response to a determination that the data throughput saturation measure approximates or exceeds one or more saturation thresholds; and
repeating the releasing and measuring operations in response to a determination that the data throughput saturation does not approximate or exceed one or more saturation thresholds.

10. The method of claim 9, further comprising directing the identification of information handling system nodes, at least in part, to facilitating the release of data processing job dispatches across information handling system node network bottleneck points.

11. The method of claim 9, further comprising tuning one or more information handling system node and one or more information handling system node network operating parameters for large data processing operations.

12. The method of claim 11, further comprising preserving normal operating settings for at least the one or more information handling system nodes identified for receiving a data processing job dispatch.

13. The method of claim 12, further comprising restoring the one or more information handling system node and information handling system network operating parameters to their respective preserved normal operation settings.

14. The method of claim 9, further comprising continuing the releasing, measuring, pausing and repeating operations until the ‘n’ data processing job dispatches have been released for processing.

15. The method of claim 9, further comprising identifying groups of information handling system nodes for receiving a data processing job dispatch where each of the group of information handling system nodes has associated therewith a respective information handling system node rack switch.

16. A system for managing the dispatching of a massive data processing operation among a plurality of information handling system nodes, the massive data processing operation including a plurality of jobs to be processed, the system comprising:
at least one processor;
memory operably associated with the at least one processor;
a communication interface operably associated with the memory and the processor; and
a program of instructions storable in the memory and executable in the processor, the program of instructions operable to distribute at least a portion of a large data processing job across a plurality of network information handling system nodes such that data processing operations are distributed substantially evenly across one or more network bottleneck points, monitor network traffic at one or more points to ascertain a proximity of the network traffic to a saturation threshold, and continue distribution of at least a portion of a large data processing job substantially evenly across the one or more bottleneck points while data processing operations remain to be performed and the monitored network traffic does not approximate a saturation threshold.

17. The system of claim 16, further comprising the program of instructions operable to map a deployment of a plurality of networked information handling system nodes.

18. The system of claim 17, further comprising the program of instructions operable to:
identify deployment data throughput bottleneck points;
measure a saturation threshold for the one or more throughput bottleneck point; and
access stored saturation threshold measures.

19. The system of claim 16, further comprising the program of instructions operable to tune one or more aspects of networked information handling system node performance to optimize the networked information handling system node performance for performing large data processing job operations.

20. The system of claim 19, further comprising the program of instructions operable to maintain one or more networked information handling system node operating parameters reflecting normal operation of the network information handling system node performance.

21. The system of claim 20, further comprising the program of instructions operable to restore the networked information handling system nodes to their respective normal operation following completion of a large data processing operation.
